(19) United States
(12) Patent Application Publication
(10) Pub. No.: US 2019/0113336 A1
(43) Pub. Date: Apr. 18, 2019

(54) Multi-Directional Triangulation Measuring System with Method

(71) Applicant: Siemens Aktiengesellschaft, Muenchen (DE)

(72) Inventors: Martin Kördel, Charlotte, NC (US); Helmuth Euler, Glonn (DE); Anton Schick, Velden (DE)

(73) Assignee: Siemens Aktiengesellschaft, Muenchen (DE)

(21) Appl. No.: 16/088,940

(22) PCT Filed: Oct. 26, 2016
(86) PCT No.: PCT/EP2016/075762

§ 371 Date: Sep. 27, 2018

(30) Foreign Application Priority Data
Mar. 30, 2016 (DE) 10 2016 205 219.5

(51) Int. Cl. G01B 11/25; G01B 11/02; G06F 17/50; G01B 11/03

(52) U.S. Cl. CPC G01B 11/2545; G01B 11/254; G01B 11/03; G06F 17/5086; G01B 11/026

(57) ABSTRACT

Various embodiments may include a measuring apparatus for the 3D measurement of an object having a recess by means of triangulation comprising: a single capture device; and an optical device placed between the single capture device and the object. The optical device generates a plurality of separate optical paths which divide a single original field of view of the capture device into a plurality of sub-fields of view. The single capture device captures the sub-fields of view separately.

### CROSS-REFERENCE TO RELATED APPLICATIONS

This application is a U.S. National Stage Application of International Application No. PCT/EP2016/075762 filed Oct. 26, 2016, which designates the United States of America, and claims priority to DE Application No. 10 2016 205 219.5 filed Mar. 30, 2016, the contents of which are hereby incorporated by reference in their entirety.

### TECHNICAL FIELD

The present disclosure relates to manufacturing. Various embodiments may include an apparatus and/or a method to measure geometric characteristics, for example, length, distance, and/or radius, within an object, e.g., a workpiece, in particular, to check adherence to dimensional tolerances.

### BACKGROUND

In known systems, slide gauges, mechanical gauges, and/or solid measures are used to check adherence to dimensional tolerances in workpieces.

### SUMMARY

The teachings of the present disclosure may include an apparatus and/or a method to measure measurement parameters, determining geometric characteristics, in particular, complex ones, for example, length, distance, angles, and/or radius, within an object, e.g., a workpiece, to check adherence to dimensional tolerances without physical contact. Various embodiments may allow a plurality of measurement parameters within a single measurement operation. In addition, other measurements should be calibrated. Various embodiments may allow a measurement without an external mechanical control, e.g., by hand, and independent of the user.

For example, some embodiments may include a method to carry out the 3D measurement of an object (0) having a recess, e.g., a groove, a gap, or a tube by means of triangulation, comprising the step relative positioning of a measuring apparatus and of the object toward each other, wherein the measuring apparatus has a single capture device (1) and an optical device (5), wherein this generates a plurality of separate optical paths between the capture device (1) and the object in such a way that a single original field of view of the capture device (1) without an optical device (5) is divided into a plurality of sub-fields of view, wherein the single capture device (1) captures the sub-fields of view separately, wherein the relative positioning is carried out in such a way that at least two sub-fields of view capture the object.

In some embodiments, at least two sub-fields of view are symmetrical with a reference plane.

In some embodiments, two sub-fields of view are generated along two routes, which run parallel to each other and symmetrical with a reference plane, in particular a symmetry plane, of the measuring apparatus.

In some embodiments, three sub-fields of view are generated along two routes, which run symmetrical to a reference plane, in particular, a symmetry plane, of the measuring apparatus.

In some embodiments, at least one projection device (3) generates a pattern in each sub-field of view for active triangulation, which is projected onto the object.

In some embodiments, a stereo system is designed for each sub-field of view in the single capture device (1) for passive triangulation, by means of which the object is respectively captured.

In some embodiments, the relative positioning is carried out by means of an operator's hand or in an automated manner, and particularly by means of a robot.

In some embodiments, the relative positioning is carried out in such a way that at least two sub-fields of view scan a recess of the object, wherein measurement parameters to be determined particularly include widths, depths, angles of walls and/or radii of the object.

In some embodiments, at least two sub-fields of view are symmetrical with a reference plane and, at a relative position, at least one absolute measurement value is detected for at least one measurement parameter to be determined.

In some embodiments, the relative positioning entails a relative rotation of the measuring apparatus and of the object toward each other and at least one series of absolute measurement values is detected for at least one measurement parameter to be determined.

In some embodiments, the speed of a measurement value capture carried out by means of a measuring apparatus is greater than the speed of a rotational position change.

In some embodiments, by means of a computing device, a minimum is determined as an actual measurement value from a series of absolute measurement values of a measurement parameter to be determined.

In some embodiments, the relative rotation, in particular, entails multiple rotations or rotating back and forth.

In some embodiments, by means of the computing device, the measurement values are evaluated by means of additional information, in particular, from a CAD model of the object and/or of the rotational axes of the relative rotation.

In some embodiments, the measuring apparatus has a storage device, a display device and, in particular, a printing device, by means of which the respective actual measurement values are digitally stored, displayed and, in particular, printed out.

In some embodiments, by means of an image-element clock system, time shifts are carried out on image elements of the capture device.

In some embodiments, by means of the computing device, the triangulation is carried out based on a plurality of images generated by means of the sub-fields of view.

As another example, some embodiments include a measuring apparatus for the 3D measurement of an object (0), in particular, an object (0) having a recess, in particular a groove, a gap, or a tube, as described above, by means of triangulation, characterized in that, between a single capture device (1) and the object, an optical device (5) generating a plurality of separate optical paths is positioned, which divides a single original field of view of the capture device (1) without an optical device (5) into a plurality of sub-fields of view and the single capture device (1) captures the sub-fields of view separately.

### BRIEF DESCRIPTION OF THE DRAWINGS

The teachings herein are described in detail based on various embodiments in connection with the figures. In the figures:

FIG. 1 shows a first exemplary embodiment of an apparatus according to the teachings herein;

FIG. 2 shows a second exemplary embodiment of an apparatus according to the teachings herein;

FIG. 3 shows exemplary embodiments for objects to be measured according to the teachings herein;

FIG. 4 shows a first representation of recorded measurement data according to the teachings herein;

FIG. 5 shows a second representation of recorded measurement data according to the teachings herein;

FIG. 6 shows a representation of a method according to the teachings herein; and

FIG. 7 shows a third exemplary embodiment of an apparatus according to the teachings herein.

### DETAILED DESCRIPTION

In some embodiments, a method for the 3D measurement of an object, in particular, an object having a recess, in particular, a groove, a gap or a tube, by means of triangulation, having the step of relatively positioning a measuring apparatus and the object relative to one another is proposed, wherein the measuring apparatus has a single capture device and an optical device, wherein the latter produces a plurality of separate optical paths between the capture device and the object in such a manner that a single original field of view of the capture device without an optical device is divided into a plurality of sub-fields of view, wherein the single capture device captures the sub-fields of view separately, wherein the relative positioning is carried out in such a manner that at least two sub-fields of view capture the object. A “recess” as used herein includes a spatial area of a material body, in which no material of the body is available.

In some embodiments, a measuring apparatus for the 3D measurement of an object, in particular an object having a recess, in particular, a groove, a gap or a tube, as described above, by means of triangulation, characterized in that an optical device generating a plurality of separate optical paths between a single capture device and the object is positioned, which divides a single original field of view of the capture device without an optical device into a plurality of sub-fields of view and the single capture device captures the sub-fields of view separately, is.

In some embodiments, at least two sub-fields of view can be generated by means of the optical device, which are symmetrical with a reference plane.

In some embodiments, two sub-fields of view can be generated along two routes, which run parallel to each other and symmetrically to a reference plane, in particular a symmetry plane, of the measuring apparatus.

In some embodiments, three sub-fields of view can be generated along three routes, which run symmetrically to a reference plane, in particular a symmetry plane, of the measuring apparatus.

In some embodiments, at least one projection device can be designed for active triangulation, which generates a pattern in every sub-field of view, which is projected onto the object.

In some embodiments, a stereo system can be designed for passive triangulation for each sub-field of view within the single capture device, by means of which the object is respectively captured. In some embodiments, the relative positioning can be carried out by means of an operator's hand or in an automated manner, in particular, by means of a robot.

In some embodiments, the relative positioning can be carried out in such a way that at least two sub-fields of view scan a recess of the object, wherein measurement parameters to be determined, in particular, include widths, depths, angles of walls and/or radii of the object. By means of the measuring apparatus, contours of inner side walls and floors of an object having recesses or hollow spaces can be captured. For a viewer, the contour, which can also be referred to as an outline, of an object is a curve, which delimits the object from its environment. The outline of an object does not only depend on the shape of the object, but also on the direction from which a viewer observes the object.

In some embodiments, at least two sub-fields of view can be symmetric to a reference plane and at least one absolute measurement value for at least one measurement parameter to be determined can be captured in a relative position.

In some embodiments, the relative positioning can be a relative rotating of the measuring apparatus and of the object toward each other and at least one series of absolute measurement values can be captured for at least one measurement parameter to be determined.

In some embodiments, the speed of measurement value capturing carried out by means of the measuring apparatus can be greater than the speed of a rotational position change.

In some embodiments, by means of a computing device, a minimum can be determined as an actual measurement value from a series of absolute measurement values of a measurement parameter to be determined.

In some embodiments, relative rotation, in particular, can entail multiple rotations or rotating back and forth.

In some embodiments, the measuring apparatus can have a computing device, by means of which the determination of a respective actual measurement value can be carried out, wherein the measurement values can be evaluated by means of additional information, in particular, from a CAD model of the object and/or of the rotational axes of the relative rotation.

In some embodiments, the measuring apparatus can have a storage device, a display device and, in particular, a printing device, by means of which the respective actual measurement values can be digitally stored, displayed and, in particular, be printed out.

In some embodiments, by means of an image-element clock system, time shifts can be carried out on image elements of the capture device.

In some embodiments, by means of the computing device, the triangulation can be carried out based on a plurality of images generated by means of the sub-fields of view.

In some embodiments, by means of the projection device, a respective pattern at various triangulation angles can be projected onto the object separate from the capture device.

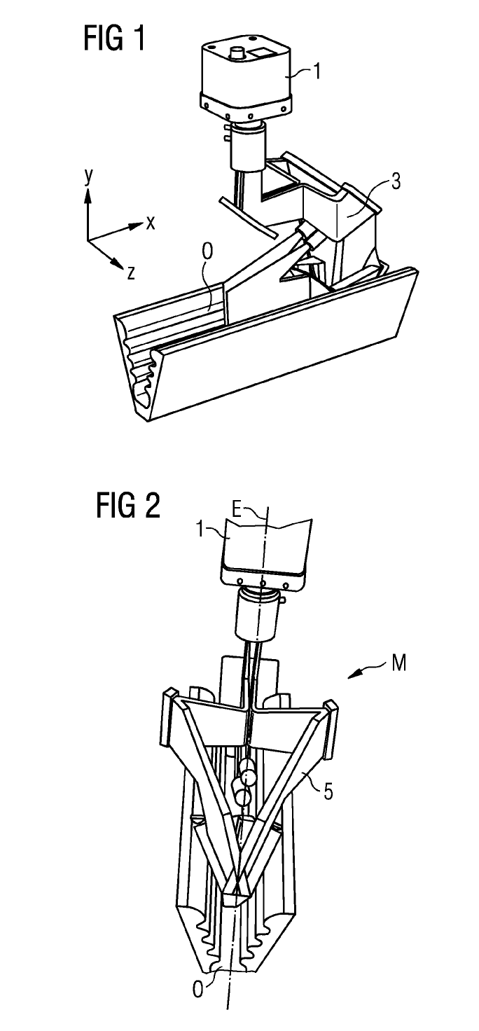

FIG. 1 shows a first example embodiment of an apparatus according to the teachings herein for the 3D measurement of an object 0, which, here, is, by way of example, a groove, by means of triangulation. The measuring apparatus has a projection device 3 for projecting a pattern onto the object 0. A capture device 1 generating a field of view with an object serves to detect a pattern. By means of an optical device generating a plurality of separately adjustable optical paths positioned between the capture device 1 and the object 0, the field of view can be divided into a plurality of sub-fields of view.

The respective x-axis, y-axis, and z-axis of an orthogonal x-, y-, z-axis coordinate system are shown in FIG. 1. The object 0 extends on a spatial level in this coordinate system. The object 0 extends, in particular, along an x-axis, which is a longitudinal axis. The measuring apparatus can also be referred to as a “multi-directional single-chip triangulation system” or as an “optic 3D probe without pre-alignment”. In particular, the triangulation is an active triangulation, which, for example, uses laser-line deformations for calculation.

FIG. 2 shows a second example embodiment of an apparatus according to the teachings herein. FIG. 2 shows a capture device 1 generating a field of view with an object to capture patterns. The measuring apparatus makes 3D measurement of an object 0 by means of triangulation possible, which is a groove here. FIG. 2 shows an optical device 5 generating a plurality of separately adjustable optical paths positioned between a capture device 1 and the object 0, which divides the field of view into a plurality of sub-fields of view. For example, the optical device 5 can have reflecting, breaking and/or bending optical elements for dividing the field of view into sub-fields of view.

FIG. 2 shows a measuring apparatus M, which is symmetrical with respect to a perpendicular symmetry plane S. Accordingly, two sub-fields of view symmetrical to each other are generated, which make the simultaneous capture, for example, of opposite groove walls possible. The division can be caused by means of refractive or diffractive elements, for example, mirrors or prisms. In this way, the field of view given due to the arrangement of a camera and an object can be divided into a plurality of sub-fields of view, however at least two sub-fields of view. By means of other optical elements, these fields of view can be guided separately and be guided to various spatial points or to an identical point. Here, by bending the optical path or by means of elongating or shortening the optical path length, imaging can be carried out at various depths, although the same lens is used.

The lighting required for active triangulation can be guided independently of it at the corresponding points. In this way, measurements at the same point with various triangulation angles can be carried out or also areas at a different depth with the same resolution can be measured without increasing the depth of focus. Splitting the field of view also allows, when observing the same point, for a type of high dynamic range application since, within the individual optical paths, different filters for brightness and wavelength can be used. Of course, other optical elements can be introduced just as well, which distort the image at the same point of the object in such a way that imaging errors can be compensated for. The precision can thus be selectively increased.

At the same time, the use of only a single camera and a single object allows for a simple and exact referencing between the individual sensors resulting from the division since no mechanical couplings are required as is the case when using separate systems. Thereby, a precise diametrical measurement is made possible. Also, the exact synchronous measurement of the subsystems is given due to the use of only a single camera since a plurality of cameras do not need to be synchronized.

Also, a so-called “pixel clock” can be used to introduce precisely defined time shifts, as this is similarly carried out in the case of TDI cameras for example. The evaluation of the image and a computer-supported discrimination of certain areas by means of a controllable aperture array is conceivable. In some embodiments, only a scene is observed as is the case with a light-field camera. A division of a field of view and a separate guide of individual fields of view to capture a plurality of pattern projections on a single camera chip via a lens takes place. A camera is an exemplary embodiment for a capture device.

FIG. 3 shows example embodiments for objects 0 to be measured. FIG. 3 shows an example of two different groove types. A groove type is on the left side, which is referred to as a pes calcaneus. A groove type is located on the right side, which is referred to as a T-groove. With the reference letters E and C, different groove widths are shown. Reference letter G illustrates a depth of a groove area. By means of uppercase letters, corresponding measurement parameters are illustrated. Other possible measurement parameters to be determined can include angles of walls and/or radii of the groove or the object in general.

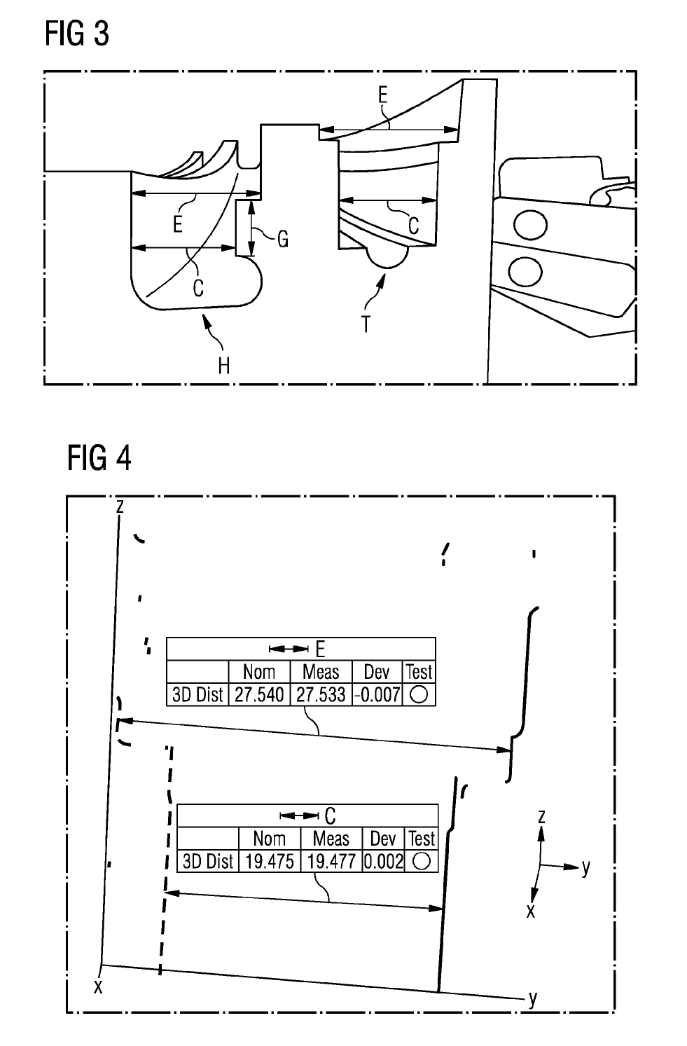

FIG. 4 shows a representation of recorded 3D measurement data. From these, measurement values of the measurement parameters to be determined can be captured. In some embodiments, the speed of a measurement value capturing carried out by means of the measuring apparatus is multiple times greater than the speed of a rotational position change. Rotational positions can be viewed as discrete rotational positions. In FIG. 4, the upper straight line shows a width E within a groove. The lower straight line illustrates a width C of a groove. Other measurement parameters are assigned to each width. In some embodiments, a relative rotation may be carried out in such a way that contours of inner side walls of the object, for example, of a groove, can be captured by means of the measuring apparatus. The measuring apparatus can have a computing device, by means of which a simple determination of a respective actual measurement value can be carried out. Furthermore, the measuring apparatus can have a storage device and a display device, by means of which the respective actual measurement values can be digitally stored and displayed.

FIG. 5 shows another representation of recorded 3D measurement data. FIG. 5 shows a temporal progression of a width C and, in addition, of a width E. FIG. 5 shows a visualization, by means of which a determination of minimums of measurement parameters can be carried out. A measuring apparatus uses for this purpose a computing device. FIG. 5 shows that, by means of the measuring apparatus, at least one absolute measurement value of a spatial embodiment of the object can be captured in any rotational position. Based on this, at least one series of absolute measurement values can be captured for at least one measurement parameter to be determined. A relative rotation of the measuring apparatus and of the object toward each other around at least a y-axis and/or z-axis is favorably carried out in such a way that, by means of the measuring apparatus, a minimum can be determined as an actual measurement value from a series of absolute measurement values. The dashed horizontal lines in FIG. 5 show these minimums. In some embodiments, the relative rotation can include rotating the measuring apparatus or rotating it back and forth for example. This relative rotation can multiply be carried out to increase a measurement precision. By means of a statistical analysis, the minimums for certain measurement parameters, such as length, distance or radius for example, can be determined from the received measurement data set based on individual measurement images, thereby determining the actual measurement value of the measurement parameter.

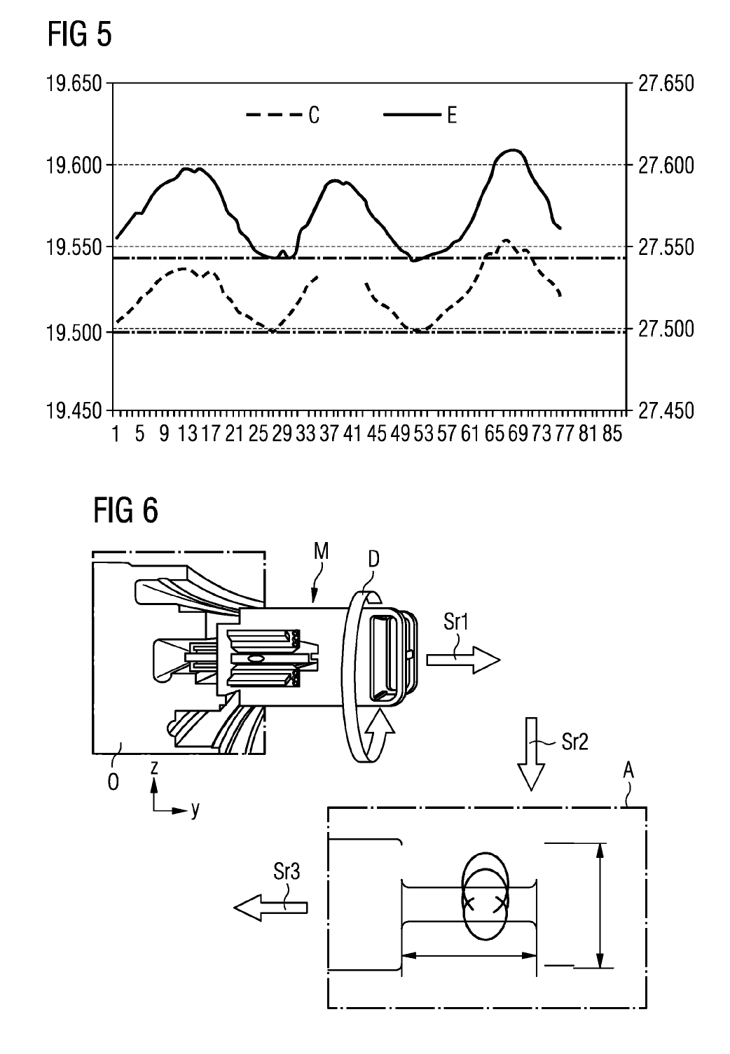

FIG. 6 shows an example embodiment of a method according to the teachings herein. FIG. 6 shows an object 0 to be measured and a measuring apparatus M. These can be rotated around at least a y-axis and a z-axis relative to each other. The arrow D illustrates this. The measuring apparatus M serves to record data. The measuring apparatus M can, for example, be moved by the hand of an operator. In some embodiments, an automated relative motion is also possible. Measurement values from the recorded data of the measuring apparatus M can be extracted. In some embodiments, a so-called multi-directional single-chip triangulation system is used as a measuring apparatus M to record the measurement data. This system can also be referred to as a multi-directional single-chip triangulation system.

The contours of the inner side walls of objects 0 are measured, which can be, for example, grooves or gaps. The measurement takes place either in a simplified way by hand or, for example, by means of a robot in an automated manner. Either the measuring device M can be rotated, or as an alternative, the object 0, which, for example, can be a workpiece. Depending on the parameters to be measured, which can include for example, a groove width, a groove depth and an angle of groove walls or radii, a rotational movement must be carried out at both or only one axis from the y-axis and the z-axis. The third groove axis, which is an x-axis in the orthogonal coordinate system, runs along the longitudinal axis of the groove and is negligible since no change of measurement parameters results.

In some embodiments, by means of the rotational movement around the vertical y- and z-axes, the measurement values for the measurement parameters to be determined change, which can, for example, be the groove width, since the measuring apparatus M determines the absolute groove width in any position. As a result of the significantly higher measurement speed in comparison to the rotational movement, in this way, a measurement series for each measurement parameter to be determined results. Since the respective measurement values, due to the absolute measurement of the measurement parameters with sufficient rotational movement, particularly around the y-axis shown in FIG. 1, have to have a minimum, the determination of this minimum provides the actual sought-after measurement value for the corresponding measurement parameter.

In some embodiments, the determination of the minimums takes place automatically by means of data processing by means of a computing device. The measurement values can be documented in digital form at the same time and be displayed after measuring on a display device, that being similar to a slide gauge with a digital display. The display device can be provided on the measuring apparatus M and/or by means of an external computer. In some embodiments, there is the option of simultaneously capturing a plurality of measurement parameters during a measurement, as well as capturing measurement parameters that are not accessible for mechanical measurement means.

In some embodiments, the following features are noted: Compared with mechanical measurements, a measuring apparatus M is quick and easy to handle, wherein, in particular, no precise calibration is required. Complex geometries can be measured, for example, beyond mechanical barriers. Also, prior knowledge, for example based on existing CAD data of the object 0 to be measured or the part to be measured can be incorporated into an automated evaluation by means of the computing device. In addition, it is also possible that photos or videos of a 3D measurement and, thereby, of the point in question to be measured can be stored in a storage device.

FIG. 6 shows an example embodiment of a method according to the teachings herein. At a first step Sr1, a measuring apparatus M can be introduced within an interior area of a groove 0 and, afterwards, be rotated relative to the groove along a rotational direction D. With a second step Sr2, a measurement of a plurality of contours is performed while rotating. Furthermore, by means of software, minimum values for widths and heights can be determined. The results can be represented by means of a display device. This is shown by means of reference letter A. By means of a third step Sr3, the parameters are evaluated by resulting contours. In some embodiments, results can be automatically stored and a measurement report can be generated.

For example, from one thousand measurement values, a percentage of the data can be used to determine the measurement value so that, in this way, accuracy can be increased. In some embodiments, an optical 3D measurement probe can be used to measure distance, for example, by means of active triangulation and/or capturing laser-line deformations by means of rotating and/or tilting toward an object 0 to be measured. A measuring apparatus M can be moved within a gap. The measuring apparatus M must not be pre-aligned. In some embodiments, a multiple contactless 3D measurement of the object contour is carried out, wherein, by means of multiple-axis rotational movements between the object and the measuring system, different relative positions are generated and an individual measurement of a respective contour takes place in every individual relative position. Then, each single recorded measurement image is evaluated. For rotary movements, a 3D measurement head having a multi-directional triangulation measurement system can be used.

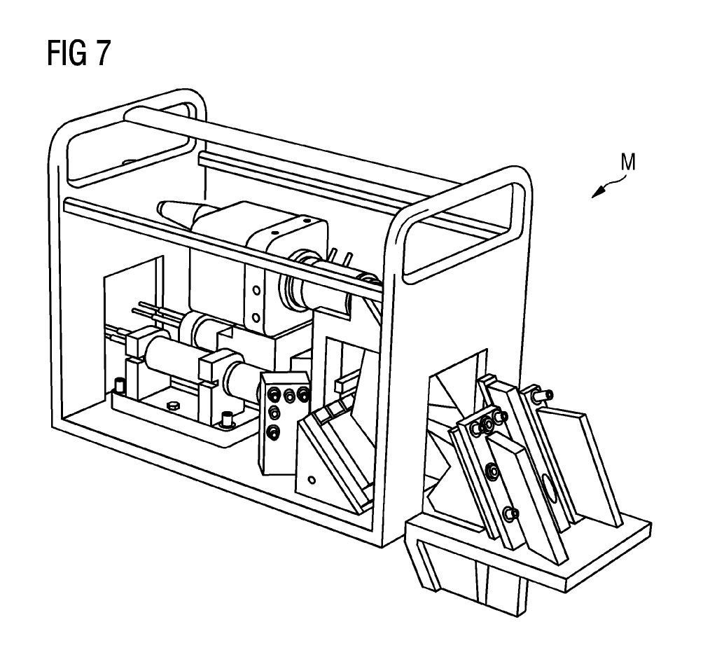

FIG. 7 shows a third exemplary embodiment of a measuring apparatus M according to the invention. The measuring apparatus M can also be referred to as a “groove rifle”.

What is claimed is:

1. A method to carry out the 3D measurement of an object by means of triangulation, the method comprising:
positioning a measuring apparatus; and
placing the object facing the measuring apparatus;
wherein the measuring apparatus comprises a single capture device and an optical device;
the measuring apparatus generates a plurality of separate optical paths between the capture device and the object in such a way that a single original field of view of the capture device without an optical device is divided into a plurality of sub-fields of view;
the single capture device captures the sub-fields of view separately; and
the positioning of the measuring apparatus provides at least two sub-fields of view capturing the object.

2. The method as claimed in claim 1, wherein at least two sub-fields of view are symmetrical with a reference plane.

3. The method as claimed in claim 2, further comprising generating two sub-fields of view along two routes running parallel to each other and symmetrical with respect to a reference plane of the measuring apparatus.

4. The method as claimed in claim 2, further comprising generating three sub-fields of view two routes running symmetrical with respect to a reference plane of the measuring apparatus.

5. The method as claimed in claim 1, wherein a projection device generates a pattern in each sub-field of view for active triangulation, and the pattern is projected onto the object.

6. The method as claimed in claim 1, wherein each sub-field of view has an associated a stereo system for passive triangulation, by means of which the object is respectively captured.

7. (canceled)

8. The method as claimed in claim 1, wherein the relative positioning of the object and the measuring device provides at least two sub-fields of view scanning a recess of the object.

9. The method as claimed in claim 8, wherein the at least two sub-fields of view are symmetrical with respect to a reference plane; and
further comprising detecting an absolute measurement value for a measurement parameter.

10. The method as claimed in claim 9, wherein the relative positioning of the object and the measuring device includes a relative rotation of the measuring apparatus and of the object toward each other; and
further comprising detecting a series of absolute measurement values for a measurement parameter.

11. The method as claimed in claim 10, wherein a speed of a measurement value capture carried out by the measuring apparatus is greater than a speed of a rotational position change.

12. The method as claimed in claim 10, further comprising determining, by means of a computing device, a minimum of a series of absolute measurement values of a measurement parameter.

13. The method as claimed in claim 10, wherein the relative rotation includes multiple rotations and/or rotating back and forth.

14. The method as claimed in claim 12, further comprising evaluating, by means of the computing device, the measurement values in light of additional information from a CAD model of the object and/or of the rotational axes of the relative rotation.

15. The method as claimed in claim 14, wherein the measuring apparatus has an associated storage device, display device, and printing device;
further comprising storing, displaying, and printing the respective actual measurement values.

16. The method as claimed in claim 1, further comprising applying time shifts, by means of an image-element clock system, on image elements of the capture device.

17. The method as claimed in claim 12, wherein, by means of the computing device, the triangulation is carried out based on a plurality of images generated by means of the sub-fields of view.

18. A measuring apparatus for the 3D measurement of an object having a recess by means of triangulation, the apparatus comprising:
a single capture device; and
an optical device placed between the single capture device and the object, the optical device generating a plurality of separate optical paths which divide a single original field of view of the capture device into a plurality of sub-fields of view;
wherein the single capture device captures the sub-fields of view separately.
